(19) United States
(12) Patent Application Publication
(10) Pub. No.: US 2007/0274366 A1
(43) Pub. Date: Nov. 29, 2007

(54) Optical unit, optical pickup apparatus and optical information-processing apparatus

(75) Inventor: Hiroyuki Oka, Mihara-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/802,540

(22) Filed: May 23, 2007

(30) Foreign Application Priority Data
May 25, 2006 (JP) 2006-145988

(51) Int. Cl. H01S 3/08

(52) U.S. Cl. 372/101

(57) ABSTRACT

In an optical pickup apparatus body, an APC light-receiving element is arranged halfway along an optical path between a collimating lens and an objective lens, at a position which is entered by laser light which enters the objective lens and spreads out of an effective diameter D1. The APC light-receiving circuit detects divergence of a light flux that has been transmitted through the collimating lens, caused by correcting spherical aberration. In an optical pickup apparatus, an APC circuit calculates based on an output signal from the APC light-receiving element to control a current supplied from an LD driving circuit to an LD so that a light amount of the light flux emitted from the objective lens is kept fixed even though the divergence is changed.

### CROSS-REFERENCE TO RELATED APPLICATION

This application claims priority to Japanese Patent Application No. 2006-145988, which was filed on May 25, 2006, the contents of which, are incorporated herein by reference, in their entirety.

### BACKGROUND OF THE INVENTION

1. Field of the Invention

The present invention relates to an optical unit, an optical pickup apparatus and an optical information-processing apparatus, which can be used for a high-density optical recording medium drive and an optical recording medium evaluation system and the like.

2. Description of the Related Art

In recent years, there has been progress in technologies with respect to optical recording/reproducing apparatuses. The optical recording/reproducing apparatuses have optical pickup devices employing laser light, and thus provide a number of advantages. That is, for example, recording/reproducing information onto/from optical recording media such as optical disks and magnetic optical disks can be achieved by non-contact with the optical recording media, and it is possible to accept any memory forms of the optical recording media, such as a play-only type, a write-once type, and a rewritable type. Therefore, the optical recording/reproducing apparatuses have been widely applied for industrial use through consumer use, as an apparatus that can achieve high-capacity media at low costs. In recent years, along with development of the optical recording/reproducing apparatuses, an attempt to record more information has been made, resulting that a trend toward high recording density of the optical recording media has been advanced and recording bits having a smaller size has been required.

When information is recorded onto a micro region on a high recording density optical disk, or recorded information thereon is reproduced, it is necessary to focus a light spot on the micro region. A size of the focused light spot is proportional to a wavelength λ of light emitted from a laser light source and inversely proportional to a numerical aperture NA of an objective lens. Therefore, efforts to reduce the wavelength λ and increase the numerical aperture NA have been made in order to reduce the size of the light spot. However, when the numerical aperture NA of the objective lens is increased, an amount of spherical aberration, caused by a difference in a thickness of a light transmission layer of the optical disc, is proportional to the fourth power of the numerical aperture NA of the objective lens.

Accordingly, it is necessary to correct the spherical aberration, caused by recording or reproducing information onto/from the optical disk whose light transmission layer is different in thickness, whenever the light transmission layer thereof is different in thickness. Conventionally, there have been proposed various kinds of spherical aberration correcting mechanisms for correcting the spherical aberration. As one example thereof, there is a mechanism for correcting the spherical aberration by moving a position of a collimating lens in a direction of an optical axis to change an divergence value as described later of a light flux that has been emitted from the collimating lens (refer to Japanese Unexamined Patent Publication JP-A 10-106012(1998)).

When the collimating lens has been moved in a direction of the optical axis to correct the spherical aberration, the light flux that has been transmitted through the collimating lens is not necessarily transformed into a light beam parallel to the optical axis, and is spread as the light flux travels in one direction of the optical axis. A degree of the spread of the light flux that has been transmitted through the collimating lens based on parallel light is referred to as the “divergence value”. When a position of the collimating lens is moved in the direction of the optical axis, the divergence value is changed. When the divergence value is changed, an amount of light of the light flux that has been transmitted through the objective lens (hereinafter referred to as “objective output power”) is also changed.

The normal operation of the optical pickup apparatus requires correction of the spherical aberration, caused by the difference in the thickness of the light transmission layer and change in temperature, and an auto power control (abbreviated as an “APC”) mechanism for keeping an output of laser light fixed. The APC mechanism is a mechanism for receiving a portion of laser light emitted from a laser light source by using a light-receiving element, adjusting a current value supplied to the laser light source so as to keep an amount of received light fixed, and thus controlling the output of the laser light (refer to Japanese Unexamined Patent Publication JP-A 2004-280909).

Furthermore, a blue-ray disk player requires a very low-power laser beam output suitable for reproducing, which is about 0.35 mW in measurement by the objective output power, thus requiring low-power lightning of the laser light emitted from a laser light source. However, when the laser light is emitted at low power, noise included in the laser light is not negligible to cause a carrier-to-noise ratio (abbreviated as a “C/N”) to deteriorate, thus causing a reproduction jitter, that is, a so-called signal read quality level to deteriorate. Therefore, there has been proposed a technology using a unit constituted by a beam attenuating plate called an attenuator and a light-transmitting glass plate. For reproduction, the noise generated on the laser light emitted from the laser light source is decreased by activating the laser light source so as to obtain the laser light having a certain level of high-power output. Also, the objective output power is decreased by attenuating the laser light by using the beam attenuating plate. As a result, it is possible to obtain reproducing light having low noise and low power (refer to Japanese Unexamined Patent Publication JP-A 2003-173531).

FIG. 14 shows a configuration illustrating an optical pickup apparatus according to the related art. FIG. 15 shows the configuration illustrating the optical pickup apparatus according to the related art, when the collimating lens is moved.

FIG. 14 shows one example of the configuration of the optical pickup apparatus having the APC mechanism, the spherical aberration correcting mechanism, and an attenuator mechanism, according to the related art. In the optical pickup apparatus, when a laser diode (abbreviated as an “LD”) driving current is supplied from a laser diode driving circuit (hereinafter occasionally abbreviated as an LD driving circuit) 1A through a laser diode (hereinafter occasionally referred to as an LD) 1, a leaser beam is emitted. The laser light emitted from the LD 1 is converted from P-polarized light to S-polarized light by a half wavelength plate (hereinafter occasionally referred to as a λ/2 plate) 7, and most of the polarized laser beam is transmitted through a polarizing beam splitter 2, partially reflected, and then enters an APC light-receiving element 3. An output signal depending on an amount of light received is sent from the APC light-receiving element 3 to an APC circuit 1B, in which the output signal is compared with an output signal corresponding to a setting value of power, and then the difference between both output signals is fed back to the LD driving circuit 1A. The LD driving circuit 1A applies a LD driving current to the laser LD 1 to consistently provide the laser light having a fixed output level.

Meanwhile, the laser light that has been transmitted through the polarizing beam splitter 2 is transmitted through a beam attenuating plate or a light-transmitting glass plate provided in an attenuator unit 4. The laser light that has been transmitted through the attenuator unit 4 is transmitted through a collimating lens 5 and then through a quarter wavelength plate (hereinafter occasionally referred to as a λ/4 plate) 8 to produce circularly polarized light, and the circularly polarized light enters an objective lens. The laser light having entered is condensed on an information recording surface of an optical disk by an objective lens 9. At this time, when the collimating lens 5 is moved in a direction of an optical axis as shown in FIG. 15 to correct the spherical aberration caused by the difference in the thickness of the light transmission layer as described above, the divergence value of the light flux emitted from the collimating lens 5 is changed.

The laser light reflected by the information recording surface of the optical disk is once again transmitted through the objective lens and then through the λ/4 plate 8 to produce linearly-polarized light. The linearly-polarized light is then transmitted through the collimating lens 5 and the attenuator unit 4 once again, and then reflected by the polarizing beam splitter 2. The reflected light enters a photodetector 6 to output a signal according to the incident light. A focusing error signal, a tracking error signal, and a radio frequency (abbreviated as an “RF”) signal are obtained from the signal.

In the optical pickup apparatus according to the related art as shown in FIG. 14, the collimating lens 5 is moved in the direction of the optical axis, as shown in FIG. 15, to correct the spherical aberration caused by the difference in the thickness of the light transmission layer of the optical disk. When the divergence value of the light flux emitted from the collimating lens 5 is changed, coupling efficiency, which is a rate of the objective output power to the amount of light of the laser light emitted from the laser light source, is also changed.

FIG. 16 shows the relationship between the divergence value of the light flux that has been transmitted through the collimating lens 5 and the output signal of the APC light-receiving element 3, when the output of the laser light emitted from the laser light source is fixed, in the optical pickup apparatus according to the related art. FIG. 17 shows the relationship between the divergence value of the light flux that has been transmitted through the collimating lens 5 and the objective output power, when the output of the laser light emitted from the laser light source is fixed, in the optical pickup apparatus according to the related art.

When the collimating lens 5 is moved in the direction of the optical axis, the divergence value of the light flux is changed. Therefore, there has been arisen a problem that the objective output power is changed, even though the output signal from the APC light-receiving element 3 is fixed, as shown in FIGS. 16 and 17. The same problem has been arisen with respect to a configuration including no attenuator mechanism.

### SUMMARY OF THE INVENTION

Objects of the invention are to provide an optical unit, an optical pickup apparatus and an optical information-processing apparatus in which an output of laser light is controlled so that an objective output power is kept fixed even though coupling efficiency of the objective lens is changed.

The invention provides an optical unit comprising:

a laser light source;

an objective lens for condensing laser light emitted from the laser light source on a recording surface of an optical recording medium;

a spherical aberration correcting section arranged halfway along an optical path between the laser light source and the objective lens, for correcting spherical aberration at a spot of light condensed by the objective lens; and

a light-receiving element arranged halfway along an optical path between the spherical aberration correcting section and the objective lens, and arranged so as to be entered by laser light spreading out of an effective diameter of the objective lens of the laser light that has been transmitted through the spherical aberration correcting section and is to enter the objective lens.

According to the invention, by using the optical unit having a light-receiving element arranged halfway along the optical path between the spherical aberration correcting section and the objective lens so as to be entered by laser light spreading out of an effective diameter of the objective lens of the laser light that has been transmitted through the spherical aberration correcting section and is to enter the objective lens, it is made possible to detect a divergence value of a light flux that has been transmitted through the spherical aberration correcting section. Based on an output signal sent from this light-receiving element, it is possible to keep the objective output power, which is an amount of light of the light flux that has been transmitted through the objective lens, fixed.

That is, it is possible to achieve a balance between correcting the spherical aberration by the spherical aberration correcting section and keeping the objective output power fixed, even though the coupling efficiency is changed in association with change in the divergence value. It is possible to correct the spherical aberration caused by a difference in a thickness of a light transmission layer of an optical recording medium and to keep the objective output power fixed. Accordingly, it is possible to achieve the optical unit that can enhance versatility for a variety of optical recording media and can improve a signal read quality level.

Further, in the invention, it is preferable that the optical unit further comprises another light-receiving element arranged at a position closer to the laser light source than the spherical aberration correcting section along the optical path, for detecting a laser light output emitted from the laser light source.

Further, according to the invention, by further comprising another light-receiving element arranged at a position closer to the laser light source than the spherical aberration correcting section along the optical path, the optical unit provides the following effects. It is possible to control a laser light output emitted from the laser light source by using another light-receiving element arranged at a position closer to the laser light source along the optical path. It is possible to further control the output of the laser light so as to detect the divergence value of the light flux that has been transmitted through the spherical aberration correcting section to keep the objective output power fixed, by using the light-receiving element arranged halfway along the optical path between the spherical aberration correcting section and the objective lens. As described above, the two or more light-receiving elements arranged at different locations can control the output of the laser light in combination so as to keep the objective output power fixed. Accordingly, it is possible to enhance the versatility for the variety of optical recording media and to improve the signal read quality level.

Further, in the invention, it is preferable that the optical unit further comprises a beam attenuating section arranged halfway along the optical path between the laser light source and the spherical aberration correcting section, for attenuating the laser light emitted from the laser light source.

Further, according to the invention, by further comprising the beam attenuating section for attenuating the laser light emitted from the laser light source, the optical unit provides the following effects. It is possible to achieve the objective output power weaker than that used for compact disks (abbreviated as “CDs”) and digital versatile disks (abbreviated as “DVDs”), in order to support blue-ray disks or the like. Also, it is possible to keep the objective output power fixed based on the output signal from the light-receiving element, corresponding to a case in which the beam attenuating section is used and a case in which the beam attenuating section is not used. Accordingly, it is possible to enhance the versatility for the variety of optical recording media and to improve the signal read quality level.

Further, the invention provides an optical pickup apparatus comprising:

the optical unit mentioned above; and

a control circuit for controlling the laser light output emitted from the laser light source based on the output signal sent from the light-receiving element.

Further, the invention provides an optical pickup apparatus comprising:

the optical unit mentioned above; and

a control circuit for controlling the laser light output emitted from the laser light source, based on the output signal sent from the light-receiving element and the other light-receiving element.

According to the invention, the control circuit can conduct a mathematical calculation to automatically estimate the objective output power based on the output signal sent from the light-receiving element of the optical unit which light-receiving element detects the divergence value of the light flux that has been transmitted through the spherical aberration correcting section. In addition, the control circuit can control the output of the laser light emitted from the laser light source so as to keep the objective output power fixed, based on the mathematical calculation. The control circuit can readily keep the objective output power fixed.

Further, according to the invention, the control circuit can control the output of the laser light emitted from the laser light source, in which the output of the laser light can be controlled by the output signal based on the divergence value of the light flux that has been transmitted through the spherical aberration correcting section, so as to keep the objective output power fixed. Accordingly, it is possible to enhance the versatility for the variety of optical recording media and to improve the signal read quality level.

Further, the invention provides an optical pickup apparatus comprising:

the optical unit mentioned above;

a determining circuit for determining whether the light attenuating section is placed on the optical path or not, by comparing the output signal from the light-receiving element and the other light-receiving element; and

a control circuit for controlling the laser light output from the laser light source based on the output signal sent from the light-receiving element and the other light-receiving element.

According to the invention, the determining circuit can determine whether the beam attenuating section is placed on the optical path or not, based on the output signal sent from the light-receiving element and the other light-receiving element. The determining circuit determines not based on a signal from a device for driving the beam attenuating section, but based on a signal from the light-receiving element for receiving the light flux that has been transmitted through the beam attenuating section on the optical path, as well as a signal from the other light-receiving element for receiving the light flux to be transmitted therethrough on the optical path. Accordingly, it is possible to directly determine whether the beam attenuating section is placed on the optical path or not. In other words, it is possible to prevent a wrong decision about switching status of the light attenuating section, caused by defective movement of the device, or the like. That is, the switching status of the beam attenuating section can be securely identified.

Further, according to the invention, the determining circuit determines whether the light attenuating section is placed on the optical path or not, by comparing the output signal sent from the light-receiving element and the other light-receiving element. The control circuit controls the laser light output from the laser light source based on the output signal sent from the light-receiving element and the other light-receiving element. Accordingly, the optical pickup apparatus comprising the determining circuit and the control circuit can keep the objective output power fixed.

Further, the invention provides an optical information-processing apparatus comprising the optical pickup apparatus mentioned above.

According to the invention, the optical information-processing apparatus comprises the optical pickup apparatus described above, so that its spherical aberration is corrected, with the result that it is made possible to achieve an optical information-processing apparatus capable of reading information from an optical recording medium and/or recording information onto an optical recording medium with laser light an output of which from the objective is kept fixed.

### BRIEF DESCRIPTION OF THE DRAWINGS

Other and further objects, features, and advantages of the invention will be more explicit from the following detailed description taken with reference to the drawings wherein:

FIG. 1 shows a configuration of an optical pickup apparatus and an optical information-processing apparatus according to a first embodiment of the invention;

FIG. 2 shows the optical pickup apparatus when a collimating lens is moved, in the first embodiment of the invention;

FIG. 3 shows dependence of an objective output power Y on an divergence value, when an output of laser light emitted from an LD is fixed, in the first embodiment of the invention;

FIG. 4 shows the dependence of an output signal of an APC light-receiving element on the divergence value, when the output of the laser light emitted from the LD is fixed, in the first embodiment of the invention;

FIG. 5 shows the dependence of the objective output power Y on the divergence value when an APC circuit conducts an APC operation, in the first embodiment of the invention;

FIG. 6 shows the configuration of an optical pickup apparatus and an optical information-processing apparatus according to a second embodiment of the invention;

FIG. 7 shows the optical pickup apparatus when a collimating lens is moved, in the second embodiment of the invention;

FIG. 8 shows the dependence of the objective output power on the divergence value, when an output of laser light emitted from an LD is fixed, in the second embodiment of the invention;

FIG. 9 shows the dependence of an output signal of a second APC light-receiving element on the divergence value, in the second embodiment of the invention;

FIG. 10 shows the dependence of the output signal of a first APC light-receiving element on the divergence value, in the second embodiment of the invention;

FIG. 11 shows the dependence of a corrected output signal X on the divergence value, when the output of the laser light emitted from the LD is fixed, in the second embodiment of the invention;

FIG. 12 shows the dependence of the objective output power Y on the divergence value, when the APC circuit conducts the APC operation, in the second embodiment of the invention;

FIG. 13 shows the configuration of an optical pickup apparatus and an optical information-processing apparatus according to a third embodiment of the invention;

FIG. 14 shows a schematic diagram illustrating the configuration of an optical pickup apparatus according to the related art;

FIG. 15 shows the configuration of an optical pickup apparatus according to the related art, when a collimating lens is moved;

FIG. 16 shows a relationship between the divergence value of a light flux that has been transmitted through the collimating lens and an output signal of an APC light-receiving element, when an output of laser light emitted from a laser light source is fixed, in the optical pickup apparatus according to the related art; and

FIG. 17 shows the relationship between the divergence value of the light flux that has been transmitted through the collimating lens and the objective output power, when the output of the laser light emitted from the laser light source is fixed, in the optical pickup apparatus according to the related art.

### DETAILED DESCRIPTION

Hereinafter, referring to the drawings, preferred embodiments of the invention will be described in detail.

Hereinafter, a plurality of embodiments of the invention will be described with reference to the accompanying drawings. In the following description, structures identical to those that are previously described in the preceding embodiments may be denoted by identical reference numbers and the overlapped description may not be repeated. When only a portion of a component is described, the other portions of the component are identical to those of the embodiments that have been previously described. It is possible to combine portions that are specifically described in each embodiment. In addition, it is possible to partially combine embodiments, as long as the combination causes no problem.

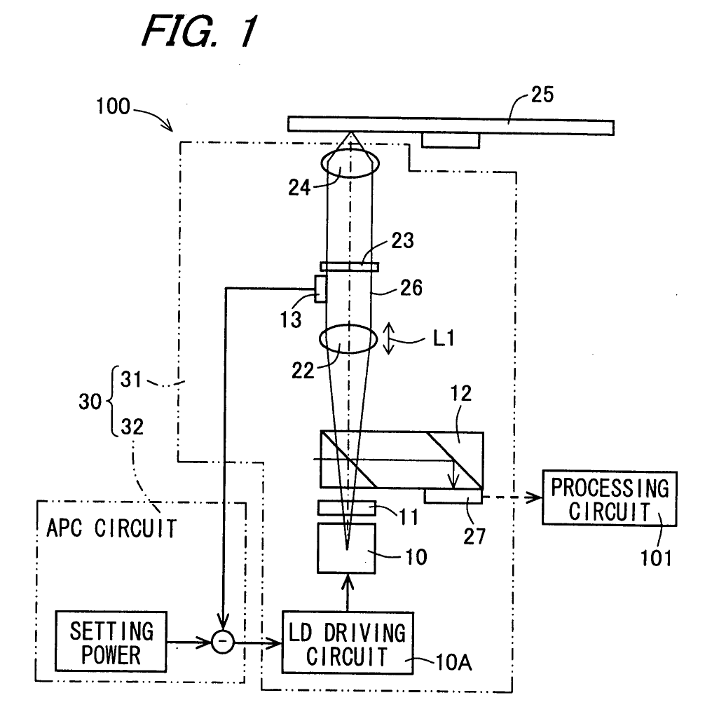

FIG. 1 shows a configuration of an optical pickup apparatus and an optical information-processing apparatus according to a first embodiment of the invention. The optical pickup apparatus according to the first embodiment 30 comprises an optical pickup apparatus main body 31 as an optical unit, and an auto power control (abbreviated as an “APC”) circuit 32. The APC circuit 32 is a control circuit for controlling an output of laser light emitted from a laser diode (abbreviated as an “LD”) 10. An optical information-processing apparatus 100 according to the first embodiment of the invention includes the optical pickup apparatus 30, and a processing circuit 101 for processing a signal outputted from the optical pickup apparatus 30.

The optical pickup apparatus main body 31 is configured to include the LD 10, a laser diode driving circuit (hereinafter occasionally abbreviated as an LD driving circuit) 10A, a half wavelength plate (hereinafter occasionally referred to as a λ/2 plate) 11, a polarizing beam splitter 12, a collimating lens 22 as a spherical aberration correcting section, a quarter wavelength plate (hereinafter occasionally referred to as a λ/4 plate) 23, an objective lens 24, an APC light-receiving element 13, and a photodetector 27. In the embodiment, the LD 10 and the LD driving circuit 10A constitute a laser light source. In the first optical pickup apparatus 30 according to the embodiment, laser light is emitted, when the LD driving circuit 10A applies a LD driving current to the LD 10. The laser light emitted from the LD 10 is converted from P-polarized light to S-polarized light by the λ/2 plate 11, and then the polarized laser beam is transmitted through the polarizing beam splitter 12. The laser light that has been transmitted through the polarizing beam splitter 12 is transmitted through the collimating lens 22. At this time, to correct spherical aberration caused by a deference in a thickness of a light transmission layer of an optical recording medium 25 and change in temperature, as shown in FIG. 1, the optical pickup apparatus 30 is configured to move the collimating lens 22 in one direction or the other direction of an optical axis by using a moving mechanism (not shown). The direction of the optical axis is denoted by an arrow L1.

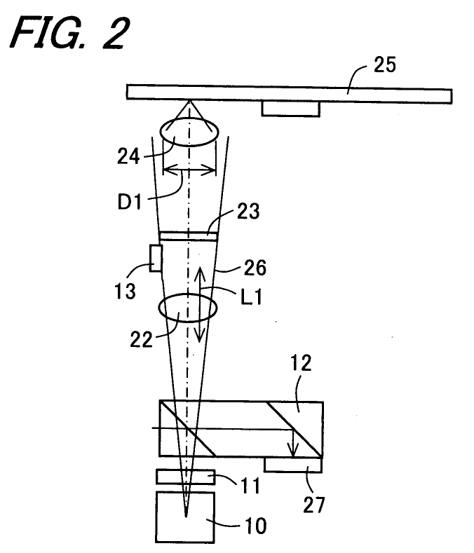

FIG. 2 shows the optical pickup apparatus when the collimating lens is moved, in the first embodiment of the invention. FIG. 2 shows a change in an divergence value of a light flux 26 that has been transmitted through the collimating lens 22, when the collimating lens 22 is moved in the direction of the optical axis. At a position through which the laser light spreading out of an effective diameter D1 of the objective lens 24, of a light flux 26 that has been transmitted through the collimating lens as the spherical aberration correcting section, passes, the APC light-receiving element 13 is arranged. At this time, the entire APC light-receiving element 13 does not necessarily have to be arranged in a region through which the laser light spreading out of the effective diameter D1 passes. That is, it is only necessary that at least a light-receiving portion of the APC light-receiving element 13 is arranged in the above-described region. This way allows the APC light-receiving element 13 to detect the divergence value that has been changed in association with correction of the spherical aberration. An output signal from the APC light-receiving element 13 is sent to the APC circuit 32 as the control circuit. The “laser beam spreading out of the effective diameter D1” herein means the “laser beam passing through out of the effective diameter D1 due to an increase in the divergence value of the light flux that has been transmitted through the spherical aberration correcting section”, and may be hereinafter referred to as the “laser beam out of the effective diameter D1”.

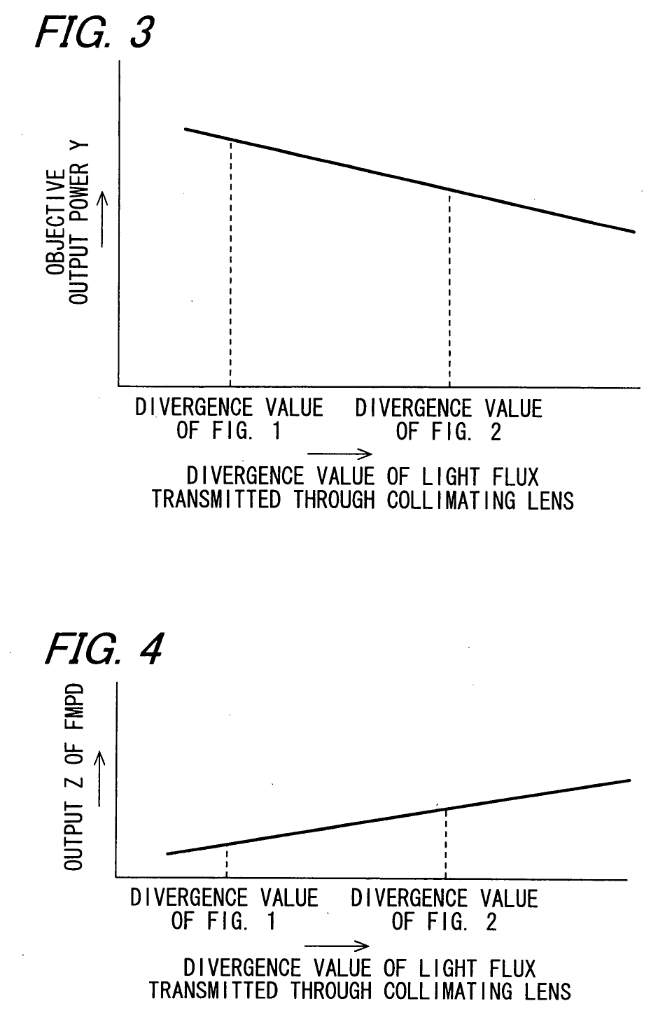

In the first embodiment of the invention, as shown in FIGS. 1 and 2, halfway along an optical path between the collimating lens 22 and the λ/4 plate 23, the APC light-receiving element 13 is arranged. The APC light-receiving element 13 may be arranged anywhere within a region which is entered by the laser light spreading out of the effective diameter D1 of the objective lens 24, of the light flux 26 that has been transmitted through the collimating lens 22. For example, the APC light-receiving element 13 may be arranged halfway along the light path between the λ/4 plate 23 and the objective lens 24, in a region in which the laser light out of the effective diameter D1 passes through the light-receiving portion of the APC light-receiving element 13. The effect to be achieved in this case is identical to that in the first embodiment. FIG. 3 shows dependence of an objective output power on the divergence value, when the output of the laser light emitted from the LD 10 is fixed, in the first embodiment of the invention. FIG. 4 shows the dependence of the output signal of the APC light-receiving element 13 on the divergence value, when the output of the laser light emitted from the LD 10 is fixed, in the first embodiment of the invention. Note that the APC light-receiving element 13 may be referred to as an “FMPD (front monitor photo diode)” in the specification and the drawings herein. As shown in FIG. 3, when the output from the LD 10 is fixed, the objective output power is decreased, and coupling efficiency, which is a rate of the objective output power to the amount of light of the laser light emitted from the LD 10, is also decreased, in association with an increase in the divergence value.

When the output of the laser light emitted from the LD 10 is fixed, an increase in the divergence value of the light flux 26 that has been transmitted through the collimating lens 22 in accordance with movement of the collimating lens 22, as shown in FIG. 2, leads to an increase in the amount of light which enters the APC light-receiving element 13. As shown in FIG. 4, the increase in the divergence value leads to an increase in the output signal from the APC light-receiving element 13. The output signal from the APC light-receiving element 13 is sent to the APC circuit 32.

In the APC circuit 32, a mathematical calculation is conducted based on the output signal from the APC light-receiving element 13 to control a current supplied from the LD driving circuit 10A to the LD 10, so as to keep the objective output power fixed in response to a change in the divergence value.

Meanwhile, the laser light which enters the objective lens 24 within the effective diameter D1 is transmitted through the λ/4 plate 23, converted to circularly polarized light, and then the circularly polarized light enters the objective lens 24. The laser light is condensed on a recording surface of the optical recording medium 25 by the objective lens 24. The laser light reflected on the recording surface is once again transmitted through the objective lens 24, the λ/4 plate 23, and the collimating lens 22, and then reflected by a polarizing beam splitter 12. The reflected light enters the photodetector 27 and a signal according to the incident light is outputted from the photodetector 27. A focusing error signal, a tracking error signal, and a RF signal are obtained from the signal. These signals are outputted to the processing circuit 101.

It is possible to determine a relationship between the objective output power and the output signal, which is used for a mathematical calculating method that is conducted based on the output signal from the APC light-receiving element 13 at the APC circuit 32 as described below. First, the output signal from the APC light-receiving element 13 is taken as Z, when the output of the laser light emitted from the LD 10 is fixed. The objective output power at this time is taken as Y. The objective output power Y can be substantially expressed as a linear function of the output signal Z as follows:

Y=αZ+β (1)

where α and β are constant numbers.

The objective output powers Y1 and Y2 corresponding to the output signals Z1 and Z2 respectively, are achieved by changing the divergence value based on the equation (1) representing that the output signal Z times the constant number α plus the constant number β equals to the objective output power Y. Then, α and β are achieved by solving the following system of linear equations (2) and (3) for α and β.

Y1=αZ1 +β (2)

Y2=αZ2 +β (3)

Accordingly, a relational expression using the objective output power Y and the output signal Z can be obtained.

In the optical pickup apparatus 30, the objective output power emitted through the objective lens can be estimated based on the output signal Z sent from the APC light-receiving element 13 to the APC circuit 32, using the constant numbers α and β obtained according to the above-described method. Therefore, the LD driving current can be determined as needed so as to keep the objective output power fixed. The LD driving circuit 10A applies the LD driving current to the LD 10 to conduct an APC operation.

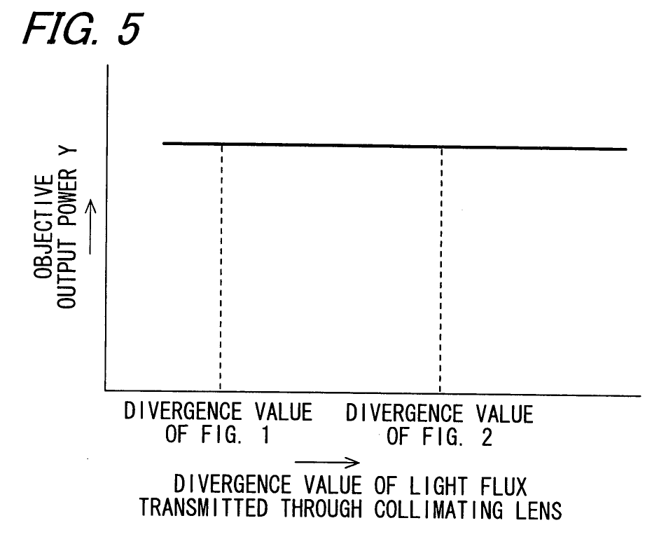

FIG. 5 shows the dependence of the objective output power Y on the divergence value when the APC circuit 32 conducts the APC operation, in the first embodiment of the invention. The objective output power Y is kept fixed, even though the divergence value is changed. As described above, even though the divergence value is changed by moving the collimating lens 22 as the spherical aberration correcting section for correcting the spherical aberration, caused by the difference in the thickness of the light transmission layer of the optical recording medium 25, it is possible to keep the objective output power fixed, thus allowing the optical pickup apparatus to enhance the versatility for the variety of optical recording media having various thicknesses and to improve the signal read quality level, compared with the optical pickup apparatus according to the related art.

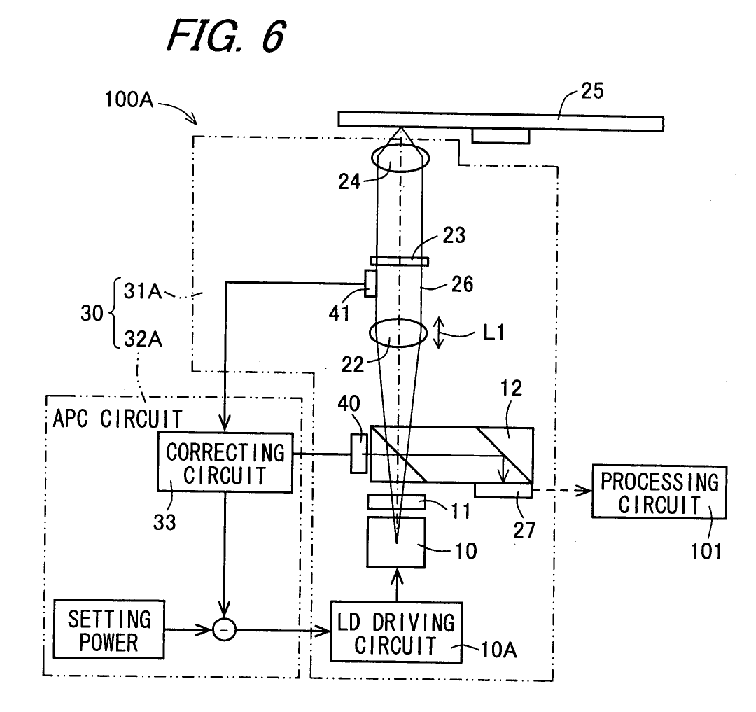

FIG. 6 shows the configuration of an optical pickup apparatus and an optical information-processing apparatus according to a second embodiment of the invention. An optical pickup apparatus 30A according to the second embodiment of the invention comprises a optical pickup apparatus main body 31A as an optical unit, and a APC circuit 32A, which is a control circuit for controlling an output of laser light emitted from the LD 10. An optical information-processing apparatus 100A according to the second embodiment of the invention includes an optical pickup apparatus 30A, and the processing circuit 101 for processing a signal outputted from the optical pickup apparatus 30A.

The optical pickup apparatus main body 31A includes the LD 10, the LD driving circuit 10A, the λ/2 plate 11, the polarizing beam splitter 12, the collimating lens 22 as the spherical aberration correcting section, the λ/4 plate 23, the objective lens 24, a first APC light-receiving element 41 as a light-receiving element, a second APC light-receiving element 40 as another light-receiving element, and the photodetector 27. In the embodiment, the LD10 and the LD driving circuit 10A constitute a laser light source. In the optical pickup apparatus 30A according to the embodiment, laser light is emitted, when the LD driving circuit 10A applies the LD driving current to the LD 10. The laser light emitted from the LD 10 is converted from the P-polarized light to the S-polarized light by the λ/2 plate 11, and then most of the polarized laser beam is transmitted through the polarizing beam splitter 12. The laser light that has been transmitted through the polarizing beam splitter 12 is transmitted through the collimating lens 22. At this time, to correct the spherical aberration caused by the difference in the thickness of the light transmission layer of the optical recording medium 25 and the change in temperature, as shown in FIG. 6, the optical pickup apparatus is configured to move the collimating lens 22 in one direction or the other direction of an optical axis by using a moving mechanism (not shown).

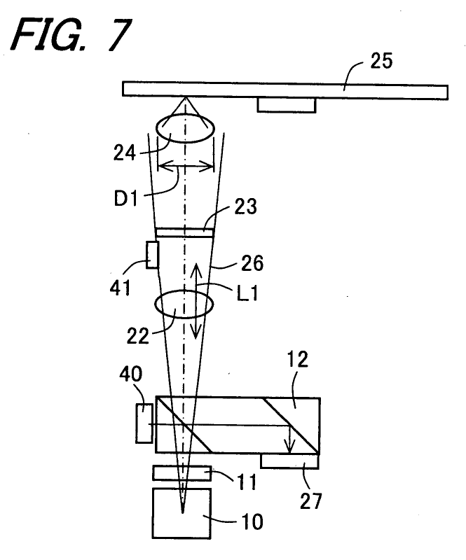

FIG. 7 shows the optical pickup apparatus when the collimating lens is moved, in the second embodiment of the invention. FIG. 7 shows a change of the divergence value of the light flux 26 that has been transmitted through the collimating lens 22, when the collimating lens 22 is moved in the direction of the optical axis. At a position through which the laser light spreading out of the effective diameter D1 of the objective lens 24, of the light flux 26 that has been transmitted through the collimating lens as the spherical aberration correcting section, passes, the first APC light-receiving element 41 is arranged. At this time, the whole of the first APC light-receiving element 41 does not necessarily have to be arranged in a region through which the laser light spreading out of the effective diameter D1 passes. That is, it is only necessary that at least a light-receiving portion of the first APC light-receiving element 41 is arranged in the above-described region. This way allows the first APC light-receiving element 41 to detect the divergence value that has been changed in association with the correction of the spherical aberration. The output signal in accordance with the amount of light received is sent from the first APC light-receiving element 41 to the APC circuit 32A, to be used for the calculation conducted at the correcting circuit 33 in the APC circuit 32A.

In the second embodiment of the invention, as shown in FIGS. 6 and 7, halfway along the optical path between the collimating lens 22 and the λ/4 plate 23, the first APC light-receiving element 41 is arranged. The first APC light-receiving element 41 may be arranged anywhere within a region which is entered by the laser light spreading out of the effective diameter D1 of the objective lens 24, of the light flux 26 that has been transmitted through the collimating lens. For example, the APC light-receiving element 41 may be arranged halfway along the optical path between the λ/4 plate 23 and the objective lens 24 in a region in which the laser light out of the effective diameter D1 passes through the light-receiving portion of the first APC light-receiving element 41. The effect to be achieved in this case is identical to that in the second embodiment of the invention.

The light flux that has been transmitted through the λ/2 plate 11 and then has entered the polarizing beam splitter 12 is partially reflected and enters the second APC light-receiving element 40. The second APC light-receiving element 40 is arranged so as to be entered by the laser light at a position closer to the laser light source than the collimating lens 22 along the optical path. The output signal in accordance with the amount of light received is sent from the second APC light-receiving element 40 to the APC circuit 32A. Therefore, a signal, which is not dependent on the movement and the divergence value of the collimating lens 22, but dependent on the output of the laser light emitted from the laser light source, is sent from the second APC light-receiving element 40 to the APC circuit 32A, to be used for the calculation conducted at the correcting circuit 33 in the APC circuit 32A.

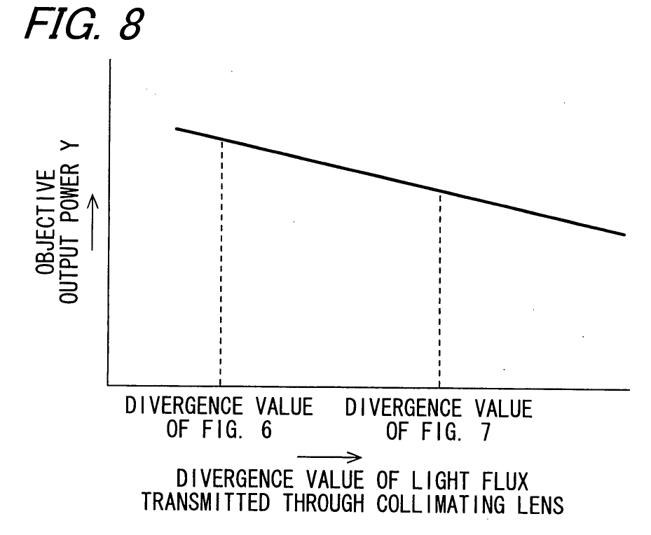

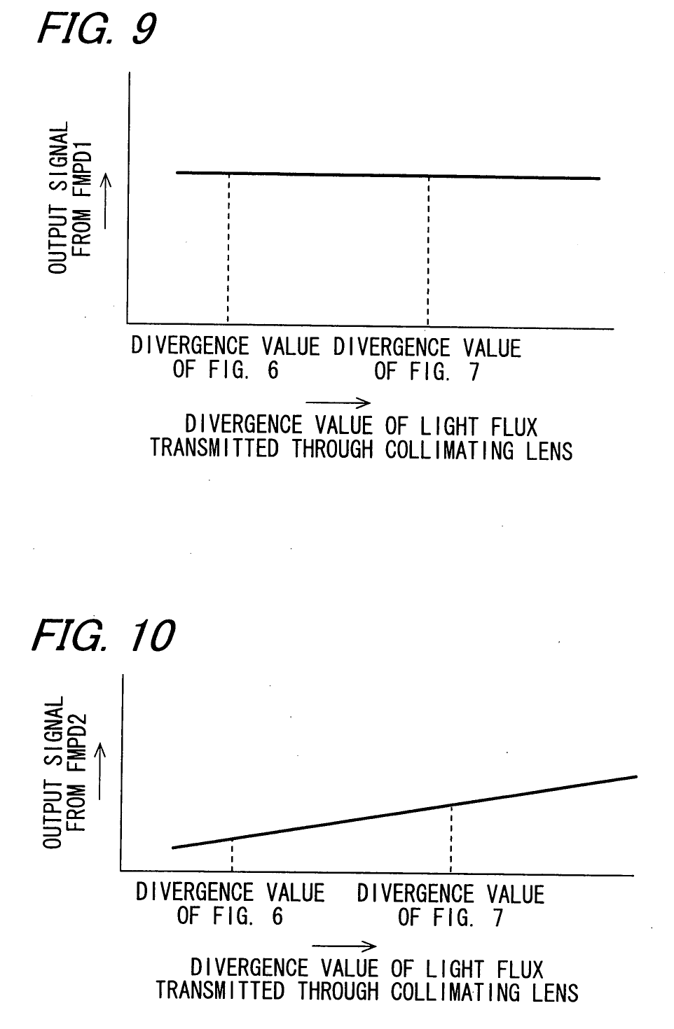

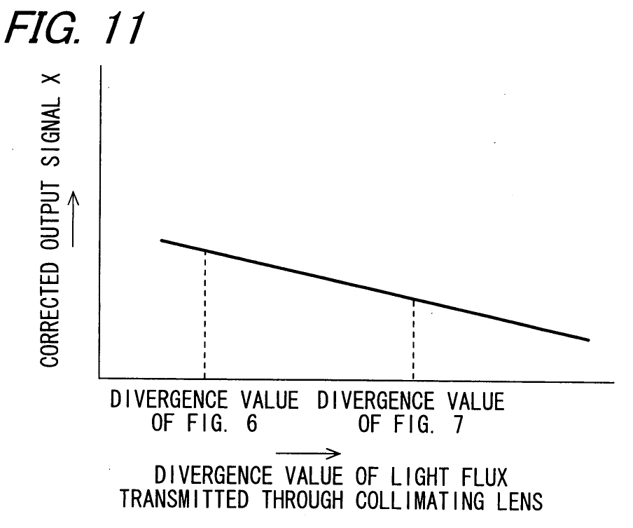

FIG. 8 shows the dependence of the objective output power on the divergence value, when the output of the laser light emitted from the LD 10 is fixed, in the second embodiment of the invention, FIG. 9 shows the dependence of the output signal from the second APC light-receiving element 40 on the divergence value in the second embodiment of the invention, and FIG. 10 shows the dependence of the output signal from the first APC light-receiving element 41 on the divergence value in the second embodiment of the invention. Note that the first APC light-receiving element 41 and the second light-receiving element 40 may be referred to as an “FMPD2” and an “FMPD1” respectively in the specification and the drawings herein. As shown in FIG. 8, when the output of the laser light emitted from the LD 10 is fixed, the objective output power is decreased, and the coupling efficiency, which is a rate of the objective output power to the amount of light of the laser light emitted from the LD 10, is also decreased, in association with an increase in the divergence value.

The amount of light of the laser light received at the second APC light-receiving element 40 is not dependent on the divergence value, the objective output power, and the coupling efficiency. Therefore, when the output of the laser light emitted from the LD 10 is fixed, as shown in FIG. 9, the output signal from the second APC light-receiving element 40 is not changed even though the divergence value is changed. The output signal is sent from the second APC light-receiving element 40 to the APC circuit 32A, to be used for the calculation conducted at the correcting circuit 33 in the APC circuit 32A.

When the output of the laser light emitted from the LD 10 is fixed, a change in the divergence value of the light flux 26 that has been transmitted through the collimating lens 22 in accordance with the movement of the collimating lens 22, as shown in FIG. 7, leads to a change in the amount of light which enters the first APC light-receiving element 41. As shown in FIG. 10, an increase in the divergence value leads to an increase in the output signal from the first APC light-receiving element 41 in proportion to the divergence value. The output signal is sent from the first APC light-receiving element 41 to the APC circuit 32A, to be used for the calculation conducted at the correcting circuit 33 in the APC circuit 32A.

The APC circuit 32A includes the correcting circuit 33 for conducting the mathematical calculation based on the output signal from the first APC light-receiving. element 41 and the APC second light-receiving element 40. The APC circuit 32A controls a current supplied from the LD driving circuit 10A to the LD 10 so as to keep the objective output power fixed in response to a change in the divergence value, based on a corrected output signal X sent from the correcting circuit 33.

Meanwhile, the laser light which enters the objective lens 24 within the effective diameter D1 is transmitted through the λ/4 plate 23, and is converted to the circularly polarized light, and then the circularly polarized laser beam enters the objective lens 24 and condensed on the recording surface of the optical recording medium 25 by the objective lens 24. The resultant laser beam reflected by the recording surface of the optical recording medium 25 is once again transmitted through the objective lens 24, the λ/4 plate 23, and the collimating lens 22, and reflected by the polarizing beam splitter 12. The reflected light enters the photodetector 27 and a signal according to the incident light is outputted from the photodetector 27. The focusing error signal, the tracking error signal, and the RF signal are obtained from the signal. These signals are outputted to the processing-circuit 101.

It is possible to determine the relationship between the objective output power and the corrected output signal used for the mathematical calculating method that is conducted at the APC circuit 32A based on the output signal from the second APC light-receiving element 40 and the first APC light-receiving element 41, as described below. First, when the output of the laser light emitted from the LD 10 is fixed, a value calculated and outputted by the correcting circuit 33 using the output signals from the second APC light-receiving element 40 and the first APC light-receiving element 41, is defined as the corrected output signal X. In the second embodiment, the value X is expressed as:

X=(Output Signal from Second APC Light-receiving Element 40)−(Output Signal from First APC Light-receiving Element 41)

FIG. 11 shows the dependence of the corrected output signal X on the divergence value, when the output of the laser light emitted from the LD10 is fixed. When the divergence value is increased, the output signal from the first APC light-receiving element 41 is increased, thus reducing the corrected output signal X. The objective output power at this time is taken as Y. When the output of the laser light emitted from the LD10 is fixed, Y is increased as X is increased. The objective output power Y can be substantially expressed as a linear function of the corrected output signal X as follows:

Y=αX+β (4)

where α and β are constant numbers.

The objective output powers Y1 and Y2 corresponding to the output signals X1 and X2 respectively, are achieved by changing the divergence value based on the equation (4) representing that the corrected output signal X times the constant number α plus the constant number β equals to the objective output power Y. Then, α and β are achieved by solving the following system of linear equations (5) and (6) for α and β.

Y1=αX1+β (5)

Y2=αX2+β (6)

Accordingly, the corrected output signal X—the objective output power Y relational expression can be obtained.

In the optical pickup apparatus, the objective output power emitted through the objective lens can be estimated by using the constant numbers α and β obtained according to the above-described method. This calculation is conducted in the APC circuit including the correcting circuit 33. Accordingly, the LD driving current can be determined as needed so as to keep the objective output power fixed. The LD driving circuit 10A applies the LD driving current to the LD 10 to conduct the APC operation.

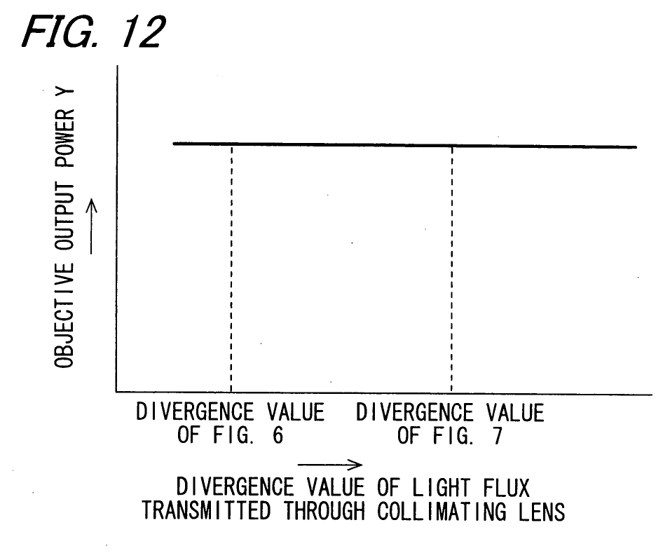

FIG. 12 shows the dependence of the objective output power Y on the divergence value, when the APC operation is conducted so as to keep the objective output power Y fixed according to the above-described method. The objective output power Y is kept fixed, even though the divergence value is changed. As described above, even though the divergence value is changed by moving the collimating lens 22 as the spherical aberration correcting section for correcting the spherical aberration, caused by the difference in the thickness of the light transmission layer of the optical recording medium 25, it is possible to keep the objective output power fixed, thus allowing the optical pickup apparatus to enhance the versatility for the variety of optical recording media and to improve the signal read quality level, compared with the optical pickup apparatus according to the related art.

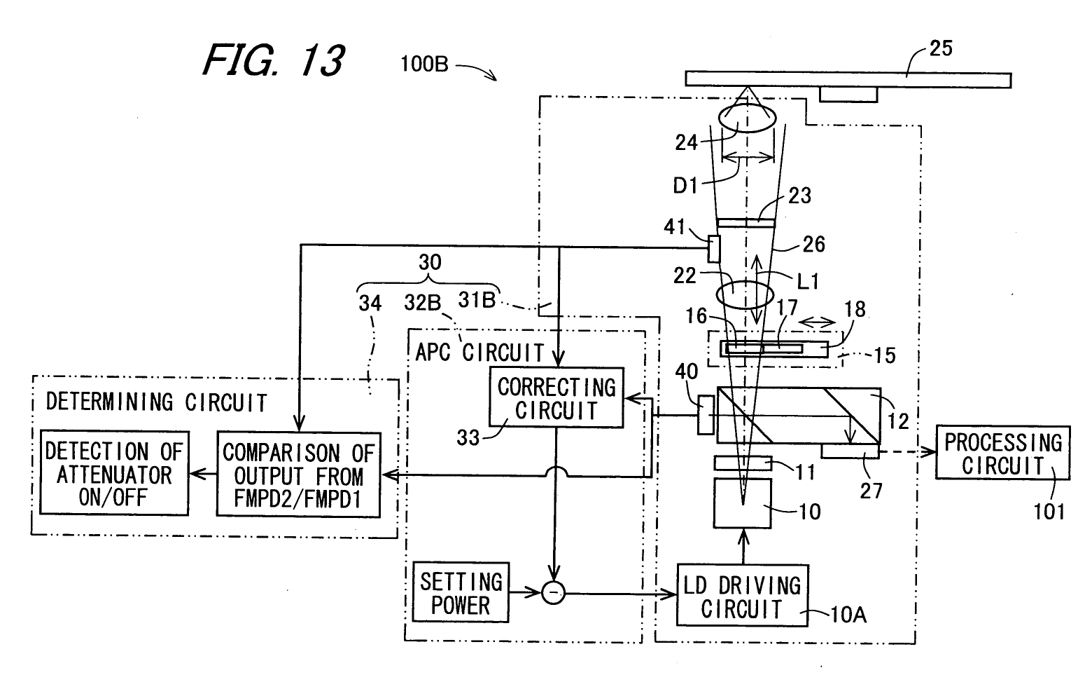

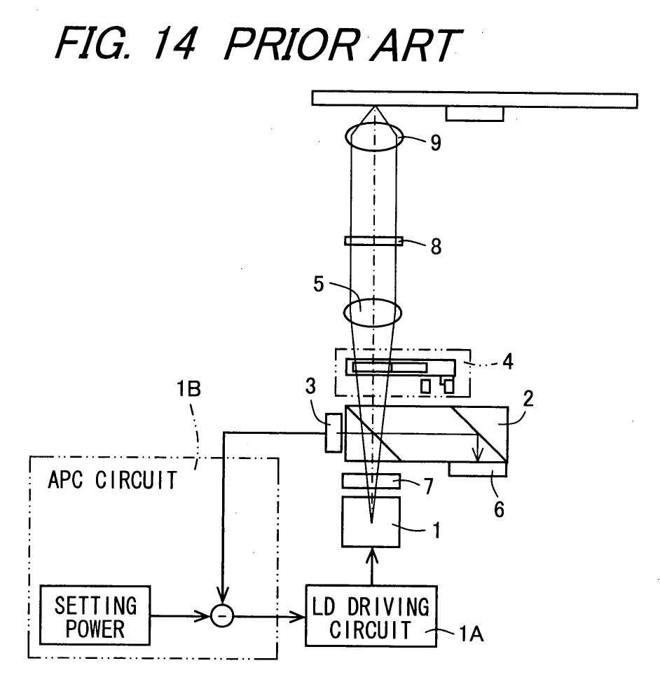

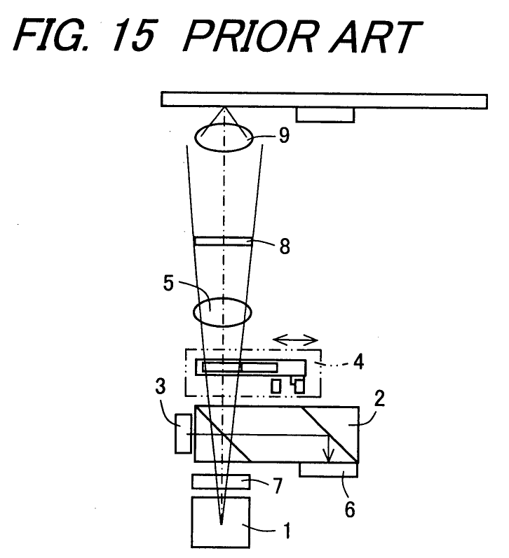

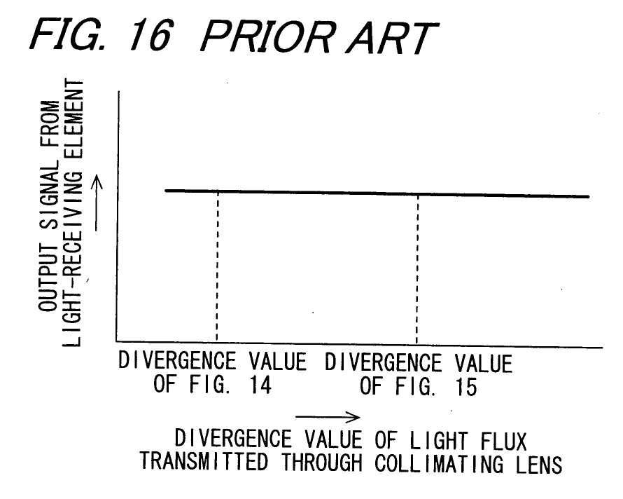

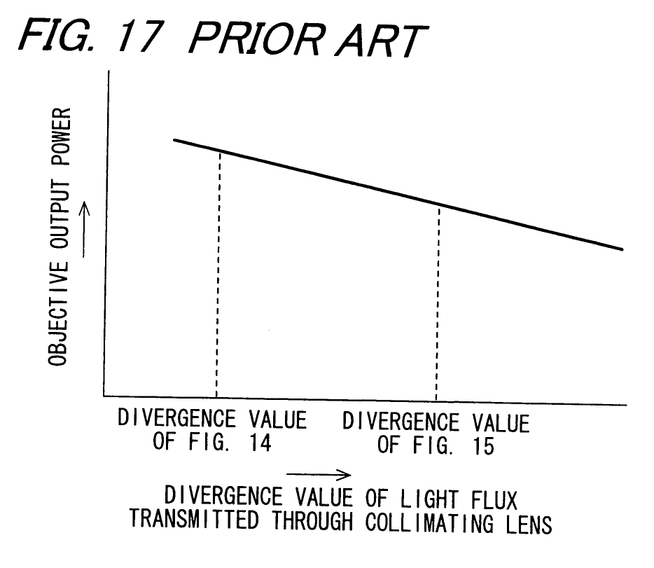

FIG. 13 shows the configuration of an optical pickup apparatus and an optical information-processing apparatus according to a third embodiment of the invention. An optical pickup apparatus 30B according to the third embodiment of the invention comprises an optical pickup apparatus main body 31B as an optical unit, a APC circuit 32B, which is a control circuit for controlling the output of the laser light emitted from the LD 10, and a determining circuit 34 for determining whether a beam attenuating section is placed or not. An optical information-processing apparatus 100B according to the third embodiment of the invention is configured to include an optical pickup apparatus 30B, and the processing circuit 101 for processing a signal outputted from the optical pickup apparatus 30B.

The optical pickup apparatus main body 31B is configured to include the LD 10, the LD driving circuit 10A, the λ/2 plate 11, the polarizing beam splitter 12, the collimating lens 22 as the spherical aberration correcting section, the first APC light-receiving element 41 as a light-receiving element, the second APC light-receiving element 40 as another light-receiving element, the beam attenuating section for attenuating the laser light emitted from the LD 10, and the photodetector 27. In the embodiment, the LD 10 and the LD driving circuit 10A constitute a laser light source. In the optical pickup apparatus 30B according to the embodiment, laser light is emitted, when the laser diode (LD) driving circuit 10A applies the LD driving current to the LD 10. The laser light emitted from the LD 10 is converted from the P-polarized light to the S-polarized light by the λ/2 plate 11, and then most of the polarized laser beam is transmitted through the polarizing beam splitter 12. The laser light that has been transmitted through the polarizing beam splitter 12 is transmitted through a beam attenuating plate 16 of an attenuator unit 15 or a light-transmitting glass plate 17. The beam attenuating plate 16 is a beam attenuating section arranged on an optical path of laser light emitted from a laser light source, for attenuating the laser light, in the third embodiment. The beam attenuating plate 16 and the light-transmitting glass plate 17 are mounted on a sliding portion 18. The sliding portion 18 is adapted to be operated by a motor or the like. That is, the sliding portion and the motor are devices for driving the beam attenuating section. The attenuator unit 15 includes the beam attenuating plate 16, the light-transmitting glass plate 17, the sliding portion 18, and the device for driving these components such as a motor.

When it is necessary to use output light emitted from the objective lens weaker than that used for CDs or DVDs to support blue-ray disks or the like, the sliding portion 18 is operated so as to place the beam attenuating plate 16 on the optical path of the laser light. When the laser light has no need to be attenuated, the sliding portion 18 is operated so as to place the light-transmitting glass plate 17 on the optical path of the laser light. The laser light that has been transmitted through the attenuator unit 15 is transmitted through the collimating lens 22 as the spherical aberration correcting section, and the laser light which enters the objective lens 24 within the effective diameter D1 is transmitted through the λ/4 plate 23, and is converted to the circularly polarized light, and then the circularly polarized laser light enters the objective lens 24 and condensed on the recording surface of the optical recording medium 25 by the objective lens 24. The resultant laser beam reflected on the recording surface is once again transmitted through the objective lens 24, the λ/4 plate 23, the collimating lens 22, and the attenuator unit 15, and reflected by the polarizing beam splitter 12. The reflected light enters the photodetector 27 and a signal according to the incident light is outputted from the photodetector 27. The focusing error signal, the tracking error signal, and the RF signal are obtained from the signal. These signals are outputted to the processing circuit 101.

The collimating lens 22 is moved in the direction of the optical axis, as shown in FIG. 13, in order to correct the spherical aberration caused by the difference in the thickness of the light transmission layer of the optical recording medium 25 and the change in temperature. At a position through which the laser light spreading out of the effective diameter D1 of the objective lens 24, of the light flux 26 that has been transmitted through the collimating lens as the spherical aberration correcting section, passes, the first APC light-receiving element 41 is arranged. At this time, the whole of the first APC light-receiving element 41 does not necessarily have to be arranged in a region through which the laser light spreading out of the effective diameter D1 passes. That is, it is only necessary that at least the light-receiving portion of the first APC light-receiving element 41 is arranged in the above-described region. This way allows the first APC light-receiving element 41 to detect the divergence value that has been changed in association with the correction of the spherical aberration. The output signal is sent from the first APC light-receiving element 41 to the APC circuit 32B, and the determining circuit 34 as described later.

The light flux that has been transmitted through the λ/2 plate 11 and then has entered the polarizing beam splitter 12 is partially reflected and enters the second APC light-receiving element 40. The second APC light-receiving element 40 is arranged so as to be entered by the laser light at a position closer to the laser light source than the attenuator unit 15 along the optical path. The output signal from the second APC light-receiving element 40 is sent to the APC circuit 32B, and the determining circuit 34 as described later.

The correction of the spherical aberration caused by the movement of the collimating lens 22, the detection of the divergence value by using the first APC light-receiving element 41, and the detection of the output of the laser light emitted from the laser light source by using the second APC light-receiving element 40 as another light-receiving element in the third embodiment, are identical to those in the second embodiment of the invention.

However, in the third embodiment of the invention as shown in FIG. 13, the first APC light-receiving element 41 is arranged halfway along the optical path between the collimating lens 22 and the λ/4 plate 23. The first APC light-receiving element 41 may be arranged anywhere as long as it is entered by the laser light spreading out of the effective diameter D1 of the objective lens 24, of the light flux 26 that has been transmitted through the collimating lens.

A mechanism for stabilizing the objective output power, that is, for keeping the objective output power fixed, by using the second APC light-receiving element 40 and the first APC light-receiving element 41 in the third embodiment of the invention, is identical that in the second embodiment of the invention. The objective output power significantly depends on whether the beam attenuating plate 16 is placed on the optical path in the attenuator unit 15 or not. Therefore, it is necessary to securely detect whether the beam attenuating plate 16 is placed on the optical path or not, that is, whether an attenuator mechanism is ON or OFF, in order to control the objective output power. It is essential to detect ON/OFF for the attenuator mechanism, since operation troubles or the like with the motor or the sliding portion 18 can occur. To achieve this, in the third embodiment of the invention, the output signals from the second APC light-receiving element 40 and the first APC light-receiving element 41 are compared with each other at the determining circuit 34 to detect ON/OFF for the attenuator mechanism.

For example, when a rate of the output signal from the second APC light-receiving element 40 to the output signal from the first APC light-receiving element 41 is defined as a calculated result W at the determining circuit 34, it will be described that the calculated result W is obtained using the expression as follows:

W=(First Output Signal from APC Light-receiving Element 41)/(Second Output Signal from APC Light-receiving Element 40)

When the attenuator mechanism was changed from ON to OFF with the output of the laser light emitted from the LD 10 fixed, provided that a transmission rate of the beam attenuating plate 16 to the laser light is 50%, and the transmission rate of the light-transmitting glass plate 17 to the laser light is 100%, the output signal from the first APC light-receiving element 41 is doubled and the calculated result W is thereby doubled.

Here, a comparison between the output signal from the second APC light-receiving element 40 and the output signal from the first APC light-receiving element 41 is taken as the calculated result W obtained by calculating the rate of both signals. However, as long as a change in the calculated result W in association with ON/OFF of the attenuator mechanism is larger than a change in the calculated result W in association with the correction of the spherical aberration, or a change in the calculated result W in association with a change in the output of the laser light, any calculation may be acceptable to compare the output signal from the second APC light-receiving element 40 with the output signal from the first APC light-receiving element 41.

As described above, the comparison between the output signal from the second APC light-receiving element 40 and the output signal from the first APC light-receiving element 41 is conducted at the determining circuit 34 to detect ON/OFF of the attenuator mechanism. The determining circuit 34 determines not based on the output signal from the device for driving the beam attenuating section, but based on a signal from a light-receiving element for receiving the light flux that has been transmitted through the beam attenuating plate on the optical path, as well as a signal from another light-receiving element for receiving the light flux to be transmitted therethrough on the optical path. Therefore, it is possible to directly determine whether the beam attenuating section is placed on the optical path or not.

The calculation conducted by the correcting circuit 33 in the APC circuit 32B, the APC circuit 32B, and the APC operation by these components in the third embodiment are identical to those in the second embodiment of the invention. In the third embodiment of the invention, in particular, the constant numbers α and β are prepared for a case where the attenuator mechanism is ON and a case where the attenuator mechanism is OFF respectively. The constant numbers α and β are then used by switching the constant numbers α and β between both cases, based on a result determined by the determining circuit 34 about whether the attenuating mechanism is ON or OFF. Accordingly, the objective output power can be fixed, regardless of whether the attenuating mechanism is ON or OFF.

As a result, even though the divergence value is changed by correcting the spherical aberration, caused by the difference in the thickness of the light transmission layer of the optical recording medium 25, it is possible to keep the objective output power fixed, thus allowing the optical pickup apparatus to enhance the versatility for the variety of optical recording media and to improve the signal read quality level, compared with the optical pickup apparatus according to the related art.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical unit comprising:
a laser light source;
an objective lens for condensing laser light emitted from the laser light source on a recording surface of an optical recording medium;
a spherical aberration correcting section arranged halfway along an optical path between the laser light source and the objective lens, for correcting spherical aberration at a spot of light condensed by the objective lens; and
a light-receiving element arranged halfway along an optical path between the spherical aberration correcting section and the objective lens, and arranged so as to be entered by laser light spreading out of an effective diameter of the objective lens of the laser light that has been transmitted through the spherical aberration correcting section and is to enter the objective lens.

2. The optical unit of claim 1, further comprising another light-receiving element arranged at a position closer to the laser light source than the spherical aberration correcting section along the optical path, for detecting a laser light output emitted from the laser light source.

3. The optical unit of claim 2, further comprising a beam attenuating section arranged halfway along the optical path between the laser light source and the spherical aberration correcting section, for attenuating the laser light emitted from the laser light source.

4. An optical pickup apparatus comprising:
the optical unit of claim 1; and
a control circuit for controlling the laser light output emitted from the laser light source based on the output signal sent from the light-receiving element.

5. An optical pickup apparatus comprising:
the optical unit of claim 2; and
a control circuit for controlling the laser light output emitted from the laser light source, based on the output signal sent from the light-receiving element and the other light-receiving element.

6. An optical pickup apparatus comprising:
the optical unit of claim 3;
a determining circuit for determining whether the light attenuating section is placed on the optical path or not, by comparing the output signal from the light-receiving receiving element and the other light-receiving element; and
a control circuit for controlling the laser light output from the laser light source based on the output signal sent from the light-receiving element and the other light-receiving element.

7. An optical information-processing apparatus comprising the optical pickup apparatus of claim 4.

8. An optical information-processing apparatus comprising the optical pickup apparatus of claim 5.

9. An optical information-processing apparatus comprising the optical pickup apparatus of claim 6.
